(19) United States
(12) Patent Application Publication
(10) Pub. No.: US 2024/0019810 A1
(43) Pub. Date: Jan. 18, 2024

(54) IMAGE DISPLAY DEVICE

(71) Applicant: FUJIFILM Corporation, Tokyo (JP)

(72) Inventors: Megumi SEKIGUCHI, Minamiashigara-shi (JP); Naoyoshi YAMADA, Minamiashigara-shi (JP); Takehiro KASAHARA, Minamiashigara-shi (JP); Yukito SAITOH, Minamiashigara-shi (JP); Ryoji HIMENO, Minamiashigara-shi (JP); Makoto KAMO, Minamiashigara-shi (JP)

(73) Assignee: FUJIFILM Corporation, Tokyo (JP)

(21) Appl. No.: 18/476,500

(22) Filed: Sep. 28, 2023

Related U.S. Application Data
(63) Continuation of application No. PCT/JP2022/015551, filed on Mar. 29, 2022.

(30) Foreign Application Priority Data
Mar. 30, 2021 (JP) 2021-057082

(51) Int. Cl. G03H 1/00; G06F 3/01; G03H 1/04

(52) U.S. Cl. CPC G03H 1/0005; G06F 3/013; G03H 1/0406

(57) ABSTRACT

An object of the present invention is to provide an image display device capable of easily detecting an eye gaze. The object is achieved by providing an image display optical system; an infrared light source that irradiates an eyeball of a user with infrared light; a hologram element that transmits infrared light emitted by the infrared light source and reflected by the eyeball of the user; and an infrared light image sensor that images infrared light transmitted through the hologram element, in which the hologram element acts on infrared light without acting on visible light and emits reproduced infrared light with an intensity distribution in a plane direction corresponding to an eye gaze of the user.

### CROSS-REFERENCE TO RELATED APPLICATIONS

This application is a Continuation of PCT International Application No. PCT/JP2022/015551 filed on Mar. 29, 2022, which claims priority under 35 U.S.C. § 119(a) to Japanese Patent Application No. 2021-057082 filed on Mar. 30, 2021. The above applications are hereby expressly incorporated by reference, in their entirety, into the present application.

### BACKGROUND OF THE INVENTION

### 1. Field of the Invention

The present invention relates to an image display device such as a head-mounted display.

### 2. Description of the Related Art

As means for providing a user with virtual reality (VR) and augmented reality (AR), a head-mounted display (HMD), an AR glass, or the like has been put into practical use.

It is desired for a VR system that provides the VR and an AR system that provides the AR to incorporate a function of detecting the user's eye gaze.

By detecting the user's eye gaze, it is possible to determine what the user is observing. Accordingly, various kinds of processing become possible, such as displaying in detail what the user is observing, emphasizing what the user is observing, focusing on what the user is observing, displaying what the user is observing in high resolution, and using the user's eye gaze as a pointing device.

As a result, functions of the HMD, the AR glass, and the like are improved, which makes it possible to realize the HMD, the AR glass, and the like with higher performance.

In eye gaze detection using the HMD, the AR glass, or the like, the user's eye is irradiated with non-visible light, such as infrared light, reflected light thereof is imaged, and an obtained image is analyzed, whereby the user's eye gaze is detected.

For example, WO2016-157485A describes an HMD having a function of detecting a user's eye gaze, the HMD comprising: a convex lens disposed at a position facing the user's cornea in a case where the HMD is worn by the user; a plurality of infrared light sources that are disposed around the convex lens and that emit infrared light toward the user's cornea; a camera that captures a video including the user's cornea; and a housing that houses these, in which, in a case where a periphery of the convex lens is divided into a first region, which is a region on an outer corner side of the user's eye, a second region, which is a region on an inner corner side of the eye, a third region, which is a region on a parietal side, and a fourth region, which is a region on a chin side, the infrared light sources are disposed in the first region or the second region.

### SUMMARY OF THE INVENTION

In the HMD described in WO2016-157485A, the convenience of the HMD is improved by detecting the user's eye gaze (a direction of the eye gaze) and using this as a pointing device.

Here, in the eye gaze detection that has been conventionally incorporated into the HMD, the AR glass, or the like, including the eye gaze detection described in WO2016-157485A, the eye gaze is detected by irradiating the user's eye (eyeball) with non-visible light such as infrared light and analyzing a reflected image formed by light reflected at the eyeball.

For example, in the conventional eye gaze detection, the eye gaze is detected by irradiating the eyeball with infrared light and analyzing the reflected images of rays of non-visible light reflected at a cornea anterior surface, crystalline lens anterior and posterior surfaces, and a cornea posterior surface. These reflected images are called Purkinje images.

However, the eye gaze detection using a Purkinje image or the like has a problem of complicated computational processing and a significant calculation load.

The user's eye gaze, such as in an HMD, moves at a very high speed. Therefore, in a case where a complicated computation is performed, there may be cases where the eye gaze detection cannot keep up with the movement of the eye gaze.

In a case where the eye gaze detection cannot keep up with the movement of the eye gaze, the above-described processing, such as emphasizing what the user is observing, the operation as a pointing device, and the like cannot be performed properly.

In addition, in order to detect the eye gaze at a sufficient speed, it is necessary to take measures, such as increasing a power supply (battery) or mounting a high-performance computational processing unit.

In a case where these measures are taken, the HMD, the AR glass, and the like may become larger and heavier. Further, an amount of heat generated by a computational processing device is also increased. As a result, the wearing comfort of the HMD may be compromised.

An object of the present invention is to solve such a problem of the related art and to provide an image display device comprising an eye gaze detection function of allowing easy and quick detection of a user's eye gaze without performing complicated computation in an HMD, an AR glass, and the like.

In order to achieve the object, the present invention has the following configurations.
[1] An image display device comprising:
   an image display optical system;
   an infrared light source that irradiates an eyeball of a user with infrared light;
   a hologram element that transmits infrared light emitted by the infrared light source and reflected by the eyeball of the user; and
   an infrared light image sensor that images infrared light transmitted through the hologram element,
   in which the hologram element acts on infrared light without acting on visible light and emits reproduced infrared light with an intensity distribution in a plane direction corresponding to an eye gaze of the user.
[2] The image display device according to [1],
   in which the image display optical system includes a lens optical system and an image display element.
[3] The image display device according to [2],
   in which the infrared light image sensor is mounted on a substrate constituting the image display element together with pixels for displaying an image.
[4] The image display device according to [2],
   in which the image display element has a region through which infrared light is transmitted, and the infrared light image sensor is disposed on an opposite side of the image display element from a visual recognition side.
[5] The image display device according to [1],
   in which the image display optical system includes an image display element and a light guide plate on which an image displayed by the image display element is incident and through which the image propagates.
[6] The image display device according to [5],
   in which the light guide plate is infrared light transmissive, and
   the image display device further comprises an infrared light mirror that is disposed on an opposite side of the light guide plate from the eyeball of the user and that transmits visible light and reflects infrared light, and the infrared light image sensor receives infrared light reflected by the infrared light mirror.
[7] The image display device according to any one of [1] to [6],
   in which the hologram element is disposed between the image display optical system and the eyeball of the user.

According to the present invention, it is possible to easily detect the user's eye gaze without performing a complicated computation in the image display device such as an HMD and an AR glass.

### BRIEF DESCRIPTION OF THE DRAWINGS

FIG. 1 is a diagram conceptually showing an example of an image display device of an embodiment of the present invention.

FIG. 2 is a diagram conceptually showing an example of a pancake lens.

FIG. 3 is a conceptual diagram illustrating an operation of the image display device of the embodiment of the present invention.

FIG. 4 is a conceptual diagram illustrating the operation of the image display device of the embodiment of the present invention.

FIG. 5 is a conceptual diagram illustrating the operation of the image display device of the embodiment of the present invention.

FIG. 6 is a diagram conceptually showing another example of the image display device of the embodiment of the present invention.

FIG. 7 is a diagram conceptually showing still another example of the image display device of the embodiment of the present invention.

### DESCRIPTION OF THE PREFERRED EMBODIMENTS

Hereinafter, an image display device of an embodiment of the present invention will be described in detail with reference to preferred examples shown in the drawings.

In the present specification, a numerical range represented by “to” means a range including numerical values described before and after “to” as a lower limit value and an upper limit value, respectively.

In the present invention, visible light refers to light having a wavelength range of 380 to 780 nm. In addition, infrared light (infrared rays) refers to light having a wavelength range greater than 780 nm and equal to or less than 1600 nm.

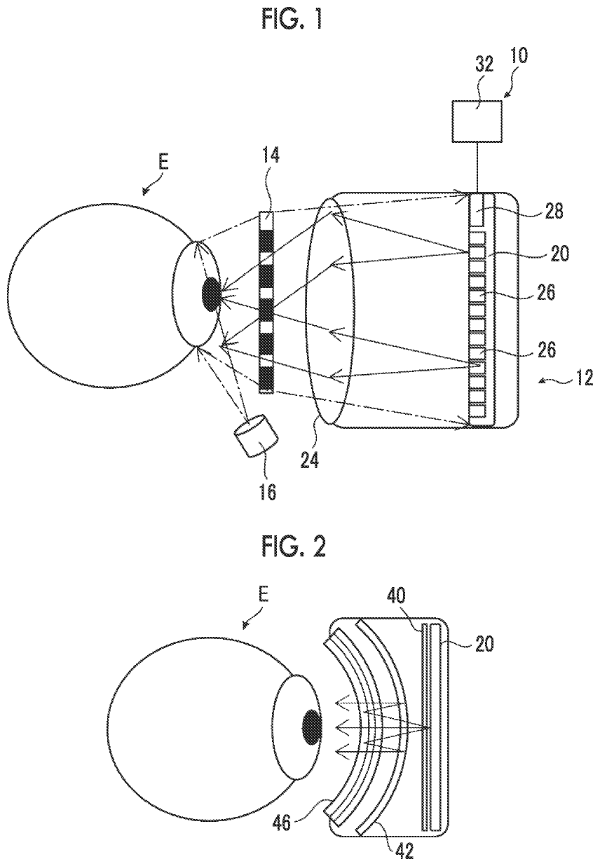

FIG. 1 conceptually shows an example in which the image display device of the embodiment of the present invention is used in a head-mounted display (HMD) which is a VR system.

An HMD 10 shown in FIG. 1 includes an image display optical system 12, a hologram element 14, and an infrared light source 16.

The image display optical system 12 is an optical system for displaying a virtual reality image (VR image), such as in an HMD, and includes an image display element 20 and a lens optical system 24.

In the HMD 10 shown in FIG. 1, similarly to a known HMD, an image displayed by the image display element 20 is observed as a virtual image through the lens optical system 24, thereby allowing a user to observe the VR image.

Here, the image display element 20 includes an infrared light image sensor 28 in addition to pixels 26 for displaying a normal VR image. In addition, an image processing unit 32 is connected to the infrared light image sensor 28.

In the present invention, the hologram element 14 is a hologram element that acts on infrared light without acting on visible light.

As described above, the HMD 10 allows the user to observe the VR image in the same manner as in a normal HMD and also irradiates an eyeball E of the user with infrared light (alternating long-dash and short-dash line) from the infrared light source 16. The infrared light reflected by the eyeball E is incident on the hologram element 14, and the infrared light diffracted by the hologram element 14 is imaged by the infrared light image sensor 28. The HMD 10 detects the user's eye gaze observing the VR image by analyzing an infrared light image through the image processing unit 32.

This point will be described in detail below.

In the HMD 10, the image display optical system 12 is basically a known optical system that displays the VR image, such as in the HMD, except that the image display element 20 includes the infrared light image sensor 28 in addition to the pixels 26 for displaying a red image, a green image, and a blue image.

Therefore, as the image display element 20, a known image display element used in a VR system such as the HMD can be used except that the infrared light image sensor 28 is mounted on a substrate constituting the image display element 20.

An example of the image display element 20 includes a liquid crystal display, an organic electroluminescence display, or a micro light emitting diode (LED) display.

The infrared light image sensor 28 mounted on the image display element 20 is also not limited, and various known infrared light image sensors can be used as long as it has sensitivity to the infrared light emitted by the infrared light source 16 and is capable of capturing the infrared light image.

An example thereof includes an area charge coupled device (CCD) sensor, a CMOS sensor, an InGaAs sensor, an organic CMOS sensor, a quantum dot sensor, or a black silicon photodiode.

The infrared light image sensor 28 need only be mounted on the substrate of the image display element 20 through a known method.

In addition, as described above, the image processing unit 32 is connected to the infrared light image sensor 28. The image processing unit 32 will be described in detail below.

The image display optical system 12 includes the image display element 20 and the lens optical system 24.

The lens optical system 24 is also a known optical system used in the VR system that displays virtual reality, such as the HMD.

An example of the lens optical system 24 includes a so-called pancake lens including a folded optical system that includes a half mirror and a reflective polarizer, a single lens, a lens array, a Fresnel lens, a liquid crystal lens, a metasurface lens, or a GRIN lens.

FIG. 2 conceptually shows an example of the pancake lens.

The pancake lens shown in FIG. 2 includes a quarter-wave plate 40, a half mirror 42, and a reflective polarizer 46 from an image display element 20 side. The reflective polarizer 46 is a reflective type circular polarizer that reflects light that is circularly polarized in one turning direction and that transmits light that is circularly polarized in an opposite turning direction.

The pancake lens is not limited to the configuration shown in FIG. 2, and various known pancake lenses used in the VR system can be used.

In the pancake lens shown in FIG. 2, as an example, the image display element 20 emits linearly polarized light as in an organic electroluminescence display including an antireflection film and a liquid crystal display device. In a case where the image display element 20 emits unpolarized light, a linear polarizer may be provided between the quarter-wave plate 40 and the image display element 20.

The image of the linearly polarized light displayed by the image display element 20 is converted into circularly polarized light in the turning direction, which is to be reflected by the reflective polarizer 46, by the quarter-wave plate 40. In the present example, as an example, the quarter-wave plate 40 converts the image of the linearly polarized light displayed by the image display element 20 into dextrorotatory circularly polarized light to be reflected by the reflective polarizer 46.

Approximately half of the image of the dextrorotatory circularly polarized light is transmitted through the half mirror and is incident on the reflective polarizer 46. The reflective polarizer 46 selectively reflects the dextrorotatory circularly polarized light. Therefore, the image of the dextrorotatory circularly polarized light is reflected by the reflective polarizer 46 and is incident on the half mirror 42 again.

Approximately half of the image of the dextrorotatory circularly polarized light incident on the half mirror 42 is reflected by the half mirror 42. During this reflection, the image of the dextrorotatory circularly polarized light is converted into levorotatory circularly polarized light.

The image of the levorotatory circularly polarized light reflected by the half mirror 42 is then incident on the reflective polarizer 46. As described above, the reflective polarizer 46 selectively reflects the dextrorotatory circularly polarized light. Therefore, the image of the levorotatory circularly polarized light is transmitted through the reflective polarizer 46 and is observed by the user as virtual reality.

In the pancake lens configured in this manner, the light is reciprocated between the half mirror 42 and the reflective polarizer 46 to increase the optical path length, which allows the user to observe the VR image as if the image (virtual image) is located at a distance.

As described above, the HMD 10 has the infrared light source 16.

In the HMD 10, infrared light (alternating long-dash and short-dash line) is emitted from the infrared light source 16 to the eyeball E of the user, infrared light reflected by the eyeball E is incident on and transmitted through the hologram element 14, and infrared light diffracted by the hologram element 14 is imaged by the infrared light image sensor 28. In the HMD 10, the infrared light image captured in this manner is analyzed by the image processing unit 32, whereby the user's eye gaze is detected.

Here, the hologram element 14 acts on infrared light without acting on visible light. In addition, the hologram element 14 emits reproduced light with an intensity distribution in a plane direction corresponding to the user's eye gaze.

The image display device of the embodiment of the present invention has such a configuration, so that it is possible to easily detect the user's eye gaze without performing complicated computation in the VR system, the AR system, or the like.

In a case of irradiating the eyeball E with infrared light for detecting the eye gaze (for eye tracking), reflection of the infrared light occurs on a surface of the eyeball E and/or on a surface of the iris after being transmitted through the cornea.

In a case where a position of the infrared light source 16 and a position of the eyeball E of the user are substantially fixed, the emitted infrared light is reflected in a distribution corresponding to a direction of the user's eye gaze on a one-to-one basis.

With regard to the reflection of the infrared light from the eyeball E generated in this manner, the infrared light emitted to the eyeball E is patterned such that the reflected light has a discrete distribution. The discrete reflection pattern from the eyeball E obtained in a case where the infrared light patterned in this way is incident can be considered to include information about the direction of the user's eye gaze, which is converted into “a position and an angle at which each light beam is incident on the hologram element 14”.

Here, the hologram element 14 can be formed so as to selectively diffract, in a specific direction, light of which an incidence position, an incidence angle at the incidence position, and a wavelength are clearly known in advance by using a technique called computer-generated hologram.

In this case, the hologram element 14 can be considered as a logical operator that converts information on the incidence position and the incidence angle of the reflected light from the eyeball E into a vector representing an emission direction and outputs the information. Therefore, in a case where the positional relationship between the infrared light image sensor 28 and the hologram element 14 is fixed, a set of pieces of vector information output from the hologram element 14 is recognized on the infrared light image sensor 28 as encoded signal light.

As described above, the discrete light beam of the reflected light from the eyeball E, which is generated based on the direction of the user's eye gaze, and the position and the incidence angle at which the reflected light is incident on the hologram element 14 have a one-to-one relationship. In addition, the position and the incidence angle of the light beam incident on the hologram element 14 and the vector of the light beam incident on the infrared light image sensor 28 from the hologram element 14 also have a one-to-one relationship.

Therefore, a set of vectors of the light beams incident on the infrared light image sensor 28 from the hologram element 14, that is, the encoded signal light, can be constructed to have a one-to-one relationship in advance with the direction of the user's eye gaze. Therefore, by reverse calculating the one-to-one relationship decided on in advance in this manner, it is possible to accurately specify the direction of the eye gaze from the obtained signal light, that is, the captured infrared light image, with low computational load.

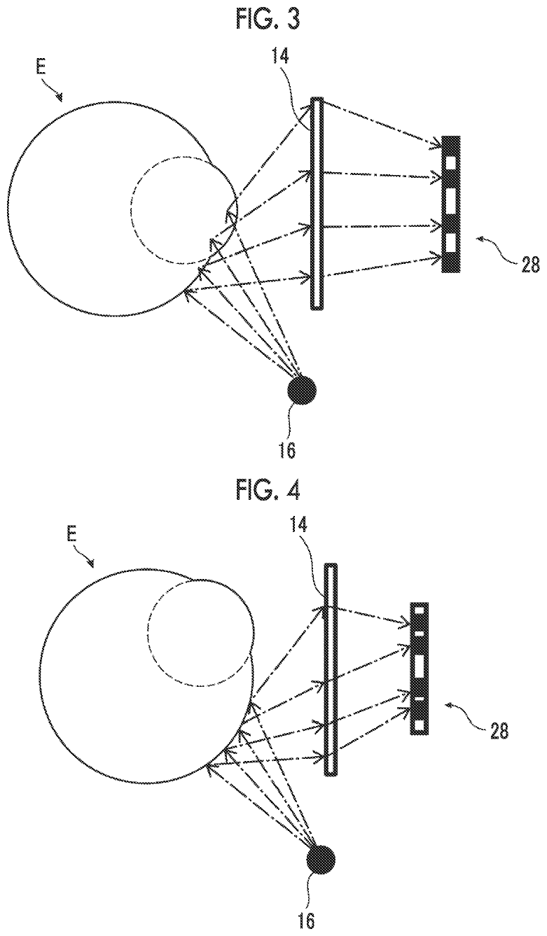

Hereinafter, a specific description will be provided with reference to the schematic diagrams of FIGS. 3 to 5. It should be noted that FIGS. 3 to 5 are presented as two-dimensional schematic diagrams for clear illustration.

FIG. 3 schematically shows a state in which the eyeball E directly faces the hologram element 14. That is, in this example, the user's eye gaze is directed straight ahead.

The infrared light beams discretely emitted from the infrared light source 16 are reflected by the eyeball E and are incident on the hologram element 14. The reflected light beam incident on the hologram element 14 is diffracted by the hologram element 14, and predetermined encoded signal light is generated. This signal light is incident on the infrared light image sensor 28 and is imaged.

FIG. 4 schematically shows a state in which the eyeball E rotates upward. That is, in this example, the user's eye gaze is directed upward.

In FIG. 4, the position of the cornea changes in conjunction with the rotation of the eyeball E, and in response to this, the position and the incidence angle at which the reflected light is incident on the hologram element 14 change. This change is converted into the vector information by the hologram element 14 to generate the encoded signal light, whereby a signal light with a code, which is unique to the direction of this eye gaze and is different from the state shown in FIG. 3 in which the eye gaze is directed straight ahead, is generated. That is, the infrared light image sensor 28 captures an infrared light image, which is unique to the state in which the eye gaze is directed upward and corresponds to the signal light.

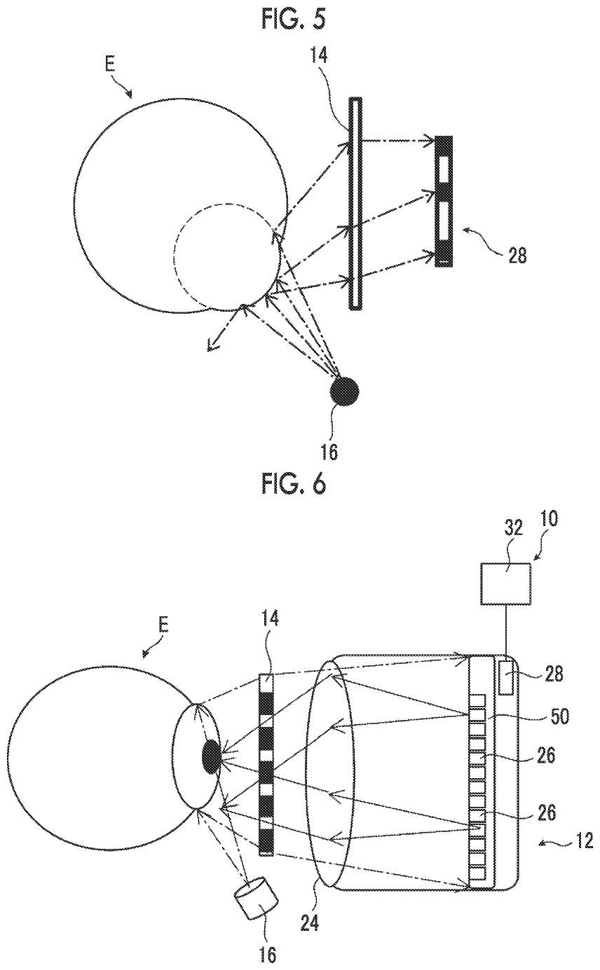

Further, FIG. 5 schematically shows a state in which the eyeball E rotates downward. That is, in this example, the user's eye gaze is directed downward.

Similarly to FIG. 4, in response to the change in the position of the cornea, a reflected light beam different from that in either FIG. 3 or FIG. 4 is incident on the hologram element 14. This change is converted into the vector information by the hologram element 14 to generate the encoded signal light, whereby a signal light with a code, which is unique to the direction of this eye gaze and is different from the state shown in FIG. 3 in which the eye gaze is directed straight ahead and from the state shown in FIG. 4 in which the eye gaze is directed upward, is generated. That is, the infrared light image sensor 28 captures an infrared light image, which is unique to the state in which the eye gaze is directed downward and corresponds to the signal light.

In this case, a location where one of light beams is incident on the hologram element 14 may be coincidentally located at the same position as one of the reflected light beams generated in the state in which the eye gaze is directed upward, as shown in FIG. 4. Even in this case as well, in a case where the hologram element 14 is an angle-multiplexed hologram element, the light beams diffracted by the hologram element 14 can be incident on an imaging element by being converted into different vectors because the incidence angles are different from each other. Therefore, there is no loss in the amount of information with respect to the encoded signal light shown in FIGS. 3 and 4. In a case where the angle-multiplexed hologram is used, the detection accuracy can be maintained in this manner.

That is, the hologram element 14 emits, according to the user's eye gaze, encoded signal light unique to the direction of that eye gaze as reproduced light in which the reflected light from the eyeball E with an intensity distribution in the plane direction, which is unique to the direction of that eye gaze, is reproduced.

In other words, the hologram element 14 generates an infrared light image which has an intensity distribution in the plane direction unique to the direction of the user's eye gaze and in which the reflected light from the eyeball E corresponding to the direction of the eye gaze is reproduced.

In the HMD 10, the image processing unit 32 stores the infrared light image based on the encoded signal light unique to the direction of each eye gaze, which is generated by the hologram element 14 in correspondence with the user's eye gaze (a rotation direction of the eyeball E), as a reference image. That is, the image processing unit 32 stores a reference table (look up table (LUT)) showing a relationship between the infrared light image, which is generated by the hologram element 14 in correspondence with each eye gaze, and the direction of the eye gaze.

Examples of the infrared light image (reference image) corresponding to the direction of the eye gaze, which is stored by the image processing unit 32, include a binarized black-and-white pattern image and a monochrome image corresponding to the intensity of infrared light.

As described above, in the HMD 10, along with the display of the VR image, the signal light (infrared light) emitted by the infrared light source 16, reflected by the eyeball E, and diffracted and encoded by the hologram element 14 is imaged by the infrared light image sensor 28.

An image signal (image data) of the infrared light image captured by the infrared light image sensor 28 is supplied to the image processing unit 32.

The image processing unit 32 performs the following processing, as an example.

In a case where an image signal of the captured image is received from the infrared light image sensor 28, the image processing unit 32 first processes the image signal to generate an image having the same format as that of the reference image stored by the image processing unit 32. In the following description, the image having the same format as that of the reference image, which is obtained by processing the image signal of the image captured by the infrared light image sensor 28, will be referred to as a “processed captured image” for convenience.

For example, the image processing unit 32 binarizes the supplied image signal to generate a black-and-white pattern image as the processed captured image. Alternatively, the image processing unit 32 processes the supplied image signal to generate a monochrome image corresponding to the intensity of infrared light as the processed captured image.

After generating the processed captured image by processing the supplied image signal, the image processing unit 32 selects the same image as or a closest image to the generated processed captured image, from the reference images corresponding to the direction of each eye gaze stored by the image processing unit 32. That is, after generating the processed captured image, the image processing unit performs matching between the reference image stored by the image processing unit 32 and the processed captured image.

The image matching need only be performed through a known method used in identification, recognition, authentication, and the like of various types of images.

After selecting the same reference image as or the closest reference image to the processed captured image, the image processing unit 32 detects the direction of the user's eye gaze corresponding to that reference image and supplies a detection result of the direction of the eye gaze to, for example, a control unit (not shown) of the image display element 20.

After receiving information on the direction of the user's eye gaze, the control unit of the image display element 20 performs, for example, processing corresponding to the user's eye gaze, such as emphasizing and displaying what the user is observing or displaying what the user is observing at high resolution, as described above.

It should be noted that the same applies to an operation of the eye gaze detection (eye tracking) in an AR system, such as an AR glass, which will be described below.

As described above, the eye gaze detection in the conventional HMD, AR glass, or the like has a problem of complicated computational processing and a significant calculation load.

On the other hand, with the image display device of the embodiment of the present invention, as described above, the eye gaze can be detected through, for example, image matching without the need for complicated computation. Therefore, according to the present invention, in the VR system such as HMD and the AR system such as an AR glass, the user's eye gaze can be easily and quickly detected without performing complicated computation.

The hologram element 14 need only be produced through various known methods.

An example thereof includes a method of producing the hologram element 14 by binarizing an image using the above-described computer-generated hologram or the like in combination with the patterned infrared light emitted by the infrared light source 16 so that a black-and-white pattern image (binarized image) unique to the direction of the eye gaze is obtained.

As another method, the hologram element 14 having a pattern such as a stripe, a check, or a grid pattern may be produced in advance. In this case, first, the direction of the eye gaze is input to, for example, the image processing unit 32 of the HMD 10. Next, in the HMD 10, the infrared light source 16 emits infrared light in a state in which the user faces the input direction of the eye gaze using the produced hologram element 14, and the infrared light reflected by the eyeball E is imaged by the infrared light image sensor 28. Then, the image processing unit 32 stores the captured image and the previously input direction of the eye gaze in association with each other. This processing is performed in various directions of the eye gaze to create a reference table showing the relationship between the infrared light image and the direction of the eye gaze.

As described above, the hologram element 14 used in the present invention acts on infrared light without acting on visible light. More specifically, display light displayed by the image display element 20 and directed toward the eyeball E is transparent. That is, the hologram element 14 is transmissive to visible light.

For example, in a case of a phase hologram, it is possible to achieve such a hologram by allowing diffraction in the visible range to exceed a diffraction limit and infrared light used for eye gaze detection (eye tracking) to fall within a diffraction range through a method such as increasing a film thickness or increasing a difference in refractive index to be formed.

In addition, in a case of an amplitude hologram, it is possible to achieve a hologram by using an absorptive or reflective material that has an absorptive or reflective property only with respect to infrared light used for eye gaze detection while exhibiting no substantial absorption in the visible range.

The hologram element 14 used in the present invention is preferably an angle-multiplexed hologram.

As described above, in a case of the angle-multiplexed hologram, even in a case where rays of reflected light are incident on the same point of the hologram element 14 and at different angles depending on the directions of the eye gaze, the diffraction directions thereof can be used as different signals for signal detection. Therefore, by using the angle-multiplexed hologram as the hologram element 14, it is possible to construct an eye gaze detection system with higher accuracy.

As the material for forming the hologram element 14 used in the present invention, various known materials capable of producing a hologram that acts on infrared light without acting on visible light, as described above, can be used.

As an example of the material for forming the hologram element 14 used in the present invention, a wet hologram material such as a dichromated gelatin material and a silver halide holographic photosensitive material, a dry hologram material containing materials, such as a photopolymer material, a photorefractive material and a photochromic material, in a binder or a matrix material, an imprint material for forming a surface pattern, a color resist material, or the like can be used.

From the viewpoint of durability, it is preferable to use a dry hologram material, an imprint material, a color resist material, or the like. Further, from the viewpoint of wavelength selectivity, it is preferable to use a dry hologram material and a color resist material.

As the dry hologram material, a material containing a photopolymer material in a binder or a matrix material can be preferably used.

Examples of these materials include those described in JP2849021B, JP3075082B, JP4142396B, and the like. In addition, a commercially available material such as Bayfol HX (trade name), which can be obtained from Bayer AG may be used.

These dry hologram materials are so-called phase holograms in which a hologram is formed by using a difference in refractive index formed in a layer. Therefore, by using the technique of the computer-generated hologram, it is possible to produce the hologram element 14 that acts only on the infrared wavelength range and is substantially transmissive in the visible range.

As the color resist material, a photocurable material (negative-type resist material) containing a coloring agent such as a dye and a pigment in a binder and a photocurable material, and a positive-type resist material in which an exposed region becomes soluble can be used.

Examples of these materials include color resist materials for infrared filters described in WO2017/130825A, WO2019/058882A, and the like. In the color resist material, by using, as the dye or the pigment to be contained, a material that is infrared absorbing while being substantially transmissive in the visible range, it is possible to form a hologram material that acts as the amplitude hologram in the infrared range and that is substantially transmissive in the visible range.

The infrared light source 16 is not limited, and various known infrared light sources can be used as long as the infrared light source can emit patterned infrared light (structured infrared light) to the entire cornea, or the cornea and the entire conjunctiva of the user.

An example of the infrared light source 16 includes an infrared LED, an infrared laser, an infrared organic light emitting diode (OLED), or a light source in which a visible light source and a wavelength conversion film are combined. In the light source in which a visible light source and a wavelength conversion film are combined, examples of the visible light source include an LED and an OLED that emit visible light. Further, examples of the wavelength conversion film include a wavelength conversion film (wavelength conversion member) using a quantum dot (QD), a phosphor, and the like.

The pattern of the infrared light emitted by the infrared light source 16 is also not limited. That is, as the pattern of the infrared light emitted by the infrared light source 16, various patterns can be used as long as uniquely encoded signal light corresponding to the user's eye gaze can be obtained in combination with the hologram element 14.

An example thereof includes a dot pattern such as a grid dot pattern and a random dot pattern, a grid line pattern, a line pattern, a checkered pattern (checkerboard pattern), or the like.

The wavelength of the infrared light emitted by the infrared light source 16 is not limited and need only be infrared light.

The wavelength of the infrared light emitted by the infrared light source 16 is preferably 800 to 1550 nm, more preferably 800 to 1000 nm, and still more preferably 800 to 950 nm.

It is preferable to set the wavelength of the infrared light emitted by the infrared light source 16 within the above-described range from the viewpoint that infrared light for eye gaze detection can be prevented from being visually recognized by the user and the infrared light can be detected with high sensitivity using the CCD sensor, the CMOS sensor, and the like.

In the HMD 10 shown in FIG. 1, the infrared light image sensor 28 is mounted on the substrate of the image display element 20, but the present invention is not limited thereto.

As an example, as conceptually shown in FIG. 6, an image display element 50 having a region through which infrared light can be transmitted may be used, and the infrared light image sensor 28 may be separated from the image display element 50.

In the example shown in FIG. 6, the infrared light image sensor 28 is disposed on an opposite side of the image display element 50 from a visual recognition side (image display surface). Accordingly, the image display element 50 does not include the pixel 26 for image display at a position corresponding to the infrared light image sensor 28, and this position serves as a region through which infrared light can be transmitted.

In the image display element 50, the region through which infrared light can be transmitted need only be provided using, for example, various known methods, such as a method of providing a through-hole and a method of using a substrate capable of transmitting infrared light as a substrate of the image display element 50.

The HMD 10 shown in FIG. 1 is an example in which the image display device of the embodiment of the present invention is used in the VR system such as an HMD, but the present invention is not limited thereto.

That is, the image display device of the embodiment of the present invention can be suitably used in the AR system such as an AR glass.

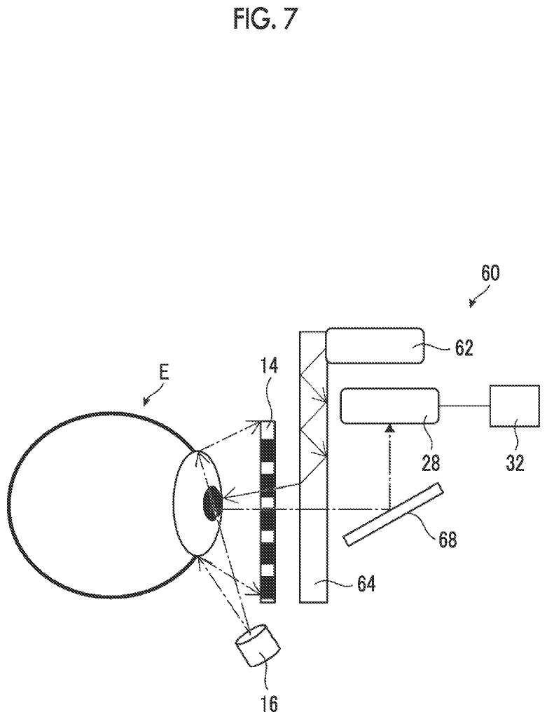

FIG. 7 conceptually shows an example in which the image display device of the embodiment of the present invention is used in the AR glass. Since the AR glass shown in FIG. 7 uses multiple members that are the same as those of the HMD 10 described above, the same members are designated by the same reference numerals, and different parts will be mainly described below.

An AR glass 60 shown in FIG. 7 includes an image display element 62, a light guide plate 64, and an infrared light mirror 68, and the hologram element 14, the infrared light source 16, the infrared light image sensor 28, and the image processing unit 32, which are described above.

In the AR glass 60, the image display optical system is composed of the image display element 62 and the light guide plate 64.

The image display element 62 is an image display element for displaying an AR image, which is used in a known AR system such as an AR glass.

Therefore, as the image display element 62, various image display elements used in the AR system, such as a liquid crystal display, an organic electroluminescence display, a micro LED display, a liquid crystal on silicon (LCOS) display, or a micro electro mechanical systems (MEMS) laser display, can be used.

Similarly to the normal AR glass, the image displayed by the image display element 62 is incident on the light guide plate 64, propagates through the light guide plate 64 by repeating total reflection, and is emitted from the light guide plate 64. The light emitted from the light guide plate 64 is observed by the user as the AR image.

As the light guide plate 64, a known light guide plate used in the AR glass can be used. It is preferable that the light guide plate 64 is infrared light transmissive.

There is no limitation on a method in which the image displayed by the image display element 62 is incident on the light guide plate 64 and the image propagating through the light guide plate 64 is emitted, and a known method can be used. The incidence and emission of light (image) with respect to the light guide plate 64 is performed preferably using a diffraction element.

The diffraction element is not limited, and various known diffraction elements, such as a liquid crystal diffraction element, a volume hologram diffraction element, and a surface relief diffraction element, can be used.

In the example shown in FIG. 6, a transmissive type diffraction element is used in a case where the diffraction element is used for the incidence and emission of light with respect to the light guide plate 64, but the present invention is not limited thereto, and a reflective type diffraction element may be used to perform the incidence and/or emission of light with respect to the light guide plate 64.

As the diffraction element, a liquid crystal diffraction element is suitably used.

The liquid crystal diffraction element is also not limited, and various known liquid crystal diffraction elements can be used.

Examples of the transmissive type liquid crystal diffraction element include a liquid crystal diffraction element described in WO2019/131918A including an optically anisotropic layer that is formed of a composition containing a liquid crystal compound and that has a liquid crystal alignment pattern in which a direction of the optical axis derived from the liquid crystal compound changes while continuously rotating along at least one direction in the plane.

In addition, examples of the reflective type liquid crystal diffraction element include a liquid crystal diffraction element described in WO2019/163944A including a cholesteric liquid crystal layer that has a liquid crystal alignment pattern in which a direction of the optical axis derived from a liquid crystal compound changes while continuously rotating along at least one direction in the plane.

Similarly to the HMD 10 shown in FIG. 1, the AR glass 60 shown in FIG. 7 allows the user to observe the AR image and uses infrared light to detect the user's eye gaze.

Similarly to the HMD 10, the AR glass 60 also irradiates the eyeball E of the user with infrared light (alternating long-dash and short-dash line) from the infrared light source 16.

The infrared light reflected by the eyeball E of the user is incident on the hologram element 14 and transmitted therethrough. As described above, the infrared light reflected by the eyeball E is diffracted by the hologram element 14, thereby obtaining uniquely encoded signal light corresponding to the direction of the eyeball E, that is, the direction of the user's eye gaze.

The infrared light transmitted through the hologram element 14 is transmitted through the light guide plate 64, is reflected by the infrared light mirror 68, is incident on the infrared light image sensor 28, and is imaged.

The infrared light mirror 68 is a mirror that transmits visible light and reflects infrared light. By reflecting the infrared light transmitted through the light guide plate 64 through the infrared light mirror 68 and causing the infrared light to be incident on the infrared light image sensor 28, the infrared light image sensor 28 can be prevented from being located within a range of the user's eye gaze.

As the infrared light mirror 68, a known mirror having wavelength selectivity, such as a dichroic mirror, which transmits visible light and reflects infrared light need only be used.

The infrared light image captured by the infrared light image sensor 28 is sent to the image processing unit 32 in the same manner as described above.

The image processing unit 32 processes the supplied infrared light image in the same manner as described above, performs matching with the infrared light image corresponding to the direction of the user's eye gaze, which is stored by the image processing unit 32, and detects the direction of the user's eye gaze using the matching result. The image processing unit 32 sends the detection result of the user's eye gaze to, for example, the control unit of the image display element 62.

In both the HMD 10 shown in FIG. 1 and the AR glass 60 shown in FIG. 7, the hologram element 14 is disposed between the image display optical system and the eyeball E of the user. In the HMD 10 shown in FIG. 1, the image display optical system is represented by a reference numeral 12, and in the AR glass 60 shown in FIG. 7, the image display optical system is the image display element 62 and the light guide plate 64.

However, in a case where the image display device of the embodiment of the present invention is used for the AR glass, the position of the hologram element 14 is not limited thereto. That is, in a case where the image display device of the embodiment of the present invention is used for the AR glass, the hologram element 14 may be disposed between the light guide plate 64 and the infrared light mirror 68, or between the infrared light mirror 68 and the infrared light image sensor 28.

Although the image display device of the embodiment of the present invention has been described above, the present invention is not limited to the above descriptions, and various improvements and changes may be made without departing from the gist of the present invention, of course.

The present invention can be suitably used in the VR system such as an HMD, the AR system such as an AR glass, and the like.

### EXPLANATION OF REFERENCES

10: HMD
12: image display optical system
14: hologram element
16: infrared light source
62: image display element
26: pixel
28: infrared light image sensor
32: image processing unit
quarter-wave plate
42: half mirror
46: reflective polarizer
AR glass
64: light guide plate
68: infrared light mirror
E: eyeball

What is claimed is:

1. An image display device comprising:
an image display optical system;
an infrared light source that irradiates an eyeball of a user with infrared light;
a hologram element that transmits infrared light emitted by the infrared light source and reflected by the eyeball of the user; and
an infrared light image sensor that images infrared light transmitted through the hologram element,
wherein the hologram element acts on infrared light without acting on visible light and emits reproduced infrared light with an intensity distribution in a plane direction corresponding to an eye gaze of the user.

2. The image display device according to claim 1,
wherein the image display optical system includes a lens optical system and an image display element.

3. The image display device according to claim 2,
wherein the infrared light image sensor is mounted on a substrate constituting the image display element together with pixels for displaying an image.

4. The image display device according to claim 2,
wherein the image display element has a region through which infrared light is transmitted, and the infrared light image sensor is disposed on an opposite side of the image display element from a visual recognition side.

5. The image display device according to claim 1,
wherein the image display optical system includes an image display element and a light guide plate on which an image displayed by the image display element is incident and through which the image propagates.

6. The image display device according to claim 5,
wherein the light guide plate is infrared light transmissive, and
the image display device further comprises an infrared light mirror that is disposed on an opposite side of the light guide plate from the eyeball of the user and that transmits visible light and reflects infrared light, and the infrared light image sensor receives infrared light reflected by the infrared light mirror.

7. The image display device according to claim 1,
wherein the hologram element is disposed between the image display optical system and the eyeball of the user.

8. The image display device according to claim 2,
wherein the hologram element is disposed between the image display optical system and the eyeball of the user.

9. The image display device according to claim 3,
wherein the hologram element is disposed between the image display optical system and the eyeball of the user.

10. The image display device according to claim 4,
wherein the hologram element is disposed between the image display optical system and the eyeball of the user.

11. The image display device according to claim 5,
wherein the hologram element is disposed between the image display optical system and the eyeball of the user.

12. The image display device according to claim 6,
wherein the hologram element is disposed between the image display optical system and the eyeball of the user.
